(19) United States
(12) Patent Application Publication
(10) Pub. No.: US 2002/0062923 A1
(43) Pub. Date: May 30, 2002

(54) METHODS FOR REDUCING VOID FORMATION UPON CURING OF ADHESIVE FORMULATIONS AND COMPOSITIONS USEFUL THEREFOR

(76) Inventor: DEBORAH D. FORRAY, SAN DIEGO, CA (US)

Correspondence Address: STEPHEN E. REITER, FOLEY & LARDNER, 402 BROADWAY, 23RD FLOOR, SAN DIEGO, CA, 92101, US

(21) Appl. No.: 09/317,493

(22) Filed: May 24, 1999

Related U.S. Application Data
(63) Continuation-in-part of application No. 08/781,995, filed on Jan. 6, 1997, now abandoned.

(51) Int. Cl. B32B 31/26

(52) U.S. Cl. 156/307.1; 156/330; 156/331.1

(57) ABSTRACT

In accordance with the present invention, adhesive formulations have been developed which enable curing of adhesively bonded assemblies (i.e., assemblies which comprise devices which have been adhesively bonded to substrates) with dramatically reduced occurrence of void formation upon curing. In many instances, void formation can be eliminated employing invention compositions. In accordance with another aspect of the present invention, methods employing the above-described adhesive formulations are also provided, as are substantially void-free articles produced thereby.

### RELATED APPLICATIONS

This application is a continuation-in-part of U.S. Ser. No. 08/781,995, now pending; the entire contents of which are hereby incorporated by reference herein.

### FIELD OF THE INVENTION

The present invention relates to compositions useful for bonding electronic devices to supports therefor, as well as methods for achieving the desired bonding and substantially void-free articles produced thereby.

### BACKGROUND OF THE INVENTION

The micro-electronics industry uses various substrates for the attachment of microelectronic devices thereto. Most of these devices are attached to suitable substrates using some kind of adhesive material. Unfortunately, many of the substrates and/or devices commonly used in the micro-electronics industry tend to absorb moisture. When subjected to the elevated temperatures required to cure such adhesive materials, various levels of void formation can occur as a result of the release of absorbed moisture and/or other volatile materials which may be released by the device and/or substrate at elevated temperatures.

The formation of voids can lead to a severe reduction in the reliability of the resulting article, due to disruption of the adhesive interface between the device and substrate. It would be desirable, therefor, to develop compositions and methods for the use thereof which allow the assembly and adhesion of device to substrate without the creation of substantial level of voids in the finished article.

### BRIEF DESCRIPTION OF THE INVENTION

In accordance with the present invention, adhesive formulations have been developed which enable curing of adhesively bonded assemblies (i.e., assemblies which comprise devices which have been adhesively bonded to substrates) with dramatically reduced occurrence of void formation upon curing. In many instances, void formation can be eliminated employing invention compositions.

In accordance with another aspect of the present invention, methods employing the above-described adhesive formulations are also provided, as are substantially void-free articles produced thereby.

### DETAILED DESCRIPTION OF THE INVENTION

In accordance with the present invention, there are provided methods to reduce void formation upon curing of an adhesive formulation employed to bond a device to a substrate, wherein said device and/or said substrate are prone to release volatiles at elevated temperatures. Invention methods comprise using as a curing catalyst for such adhesive formulations a catalyst which initiates curing of the formulation at a temperature of less than about 100° C. Accordingly, in one embodiment of the present invention, there is provided a method of obtaining a substantially void-free bond between a surface of a device and a surface of a substrate, said method comprising:

(a) applying an adhesive formulation to said surface of said device and/or said surface of said substrate, wherein said adhesive formulation comprises a curing catalyst which promotes curing of said adhesive formulation such that the cure peak maximum is no greater than about 100° C.,

(b) contacting said surface of said device with said surface of said substrate, and

(c) subjecting said adhesive formulation to a temperature sufficient to cure said adhesive, wherein said cured adhesive and a resulting bond formed therewith are substantially void-free.

In another embodiment of the present invention there is provided a single step method for rapidly thermally curing an adhesive formulation, said method comprising subjecting the adhesive formulation to a temperature sufficient to cure the adhesive,

wherein the adhesive comprises a vehicle and a curing catalyst, and

wherein the curing catalyst promotes curing of the adhesive formulation such that the cure peak maximum is no greater than about 100° C.

Adhesive formulations contemplated for use in the practice of the present invention include cyanate ester-based formulations, maleimide-based formulations, epoxy-based formulations, (meth)acrylate-based formulations, vinyl ether-based formulations, vinyl ester-based formulations, allyl ester-based formulations, diallyl amide-based formulations, propargyl ether-based formulations, formulations based on a polysiloxane backbone terminated with one or more of the above-described functional groups, formulations based on a preimidized polyimide backbone terminated with one or more of the above-described functional groups, and the like, as well as mixtures of any two or more thereof.

A wide variety of cyanate ester-based formulations are suitable for use in the practice of the present invention. Numerous examples of such formulations have been described in the art. See, for example, U.S. Pat. Nos. 5,447,988, 5,358,992, 5,489,641, each of which are hereby incorporated by reference herein in their entirety.

A wide variety of maleimide-based formulations are suitable for use in the practice of the present invention. Numerous examples of such formulations have been described in the art. See, for example, U.S. Ser. No. 08/300,721, filed Sep. 2, 1994, U.S. Ser. No. 08/460,495, filed Jun. 2, 1995, U.S. Ser. No. 08/711,982, filed Sep. 10, 1996, U.S. Pat. Nos. 4,806,608, and 4,581,461, each of which are hereby incorporated by reference herein in their entirety.

A wide variety of thermally curable (i.e., thermoset) epoxy-based formulations are suitable for use in the practice of the present invention. Numerous examples of such formulations have been described in the art. See, for example, U.S. Pat. Nos. 5,158,780 and 5,043,102, each of which are hereby incorporated by reference herein in their entirety.

A wide variety of (meth)acrylate-based formulations are suitable for use in the practice of the present invention. Numerous examples of such formulations have been described in the art. See, for example, U.S. Pat. No. 5,043,102, hereby incorporated by reference herein in its entirety.

A wide variety of vinyl ether-based formulations are suitable for use in the practice of the present invention. Numerous examples of such formulations have been described in the art. See, for example, U.S. Ser. No. 08/460,495, filed Jun. 2, 1995, which is hereby incorporated by reference herein in its entirety.

A wide variety of vinyl ester-based formulations are suitable for use in the practice of the present invention. Numerous examples of such formulations have been described in the art. See, for example, U.S. Pat. No. 5,475,048, which is hereby incorporated by reference herein in its entirety.

A wide variety of allyl ester-based formulations are suitable for use in the practice of the present invention. Numerous examples of such formulations have been described in the art. See, for example, U.S. Pat. No. 5,475,048, which is hereby incorporated by reference herein in its entirety.

A wide variety of diallyl amide-based formulations are suitable for use in the practice of the present invention. Numerous examples of such formulations have been described in the art. See, for example, each of which are hereby incorporated by reference herein in their entirety.

A wide variety of propargyl ether-based formulations are suitable for use in the practice of the present invention. Numerous examples of such formulations have been described in the art. See, for example, U.S. Ser. No. 08/684,148, filed Jul. 19, 1996, which is hereby incorporated by reference herein in its entirety.

Presently preferred adhesive formulations contemplated for use in the practice of the present invention comprise a mixture of maleimide and vinyl ether.

Optionally, adhesive formulations contemplated for use in the practice of the present invention further comprise at least one filler. Fillers contemplated for use herein include electrically conductive and thermally conductive materials, as well as non-conductive materials, which impart insulating properties to the resulting formulation.

Examples of electrically conductive fillers contemplated for use herein include silver, nickel, cobalt, copper, aluminum, metal-coated graphite fibers (e.g., employing such metals as nickel, silver, copper, and the like as the metal coating), and the like, as well as mixtures thereof. The presently preferred electrically conductive filler contemplated for use herein is silver. Both powder and flake forms of filler may be used in the attach paste compositions of the present invention. The preferred thickness of flake is under 2 microns with a dimension of about 20 to about 25 microns. Flake contemplated for use herein preferably has a surface area of about 0.15 to 5.0 m²/g and a tap density of 0.4 to 5.5 g/cc. Powder contemplated for use herein preferably has a diameter of about 0.5 to 15 microns.

Thermally conductive fillers contemplated for use in the practice of the present invention include diamond, boron nitride, alumina, aluminum nitride, silicon carbide, magnesium oxide, and the like, as well as mixtures of any two or more thereof.

Catalysts contemplated for use in the practice of the present invention are those which can be thermally initiated without the need for further activation or pretreatment. Catalysts contemplated for use in the practice of the present invention initiate curing of the adhesive formulation at a desirably low temperature, and also promote curing of adhesive formulations at a sufficiently rapid rate such that the cure peak maximum similarly occurs at a desirably low temperature, e.g., at a temperature of no greater than about 100° C. Those of skill in the art readily recognize that the concept of cure peak maximum involves two components: (1) the inititation temperature, and (2) the rate of cure. Thus, catalysts contemplated for use in the practice of the present invention initiate curing at a temperature of less than 100° C. and have a rate of cure such that the majority of the curing reaction is completed at a temperature of less than 100° C. One advantage obtained by employing such catalysts is that any volatiles released by the substrate will not be as likely to disrupt invention adhesives since the majority of volatiles will be released at a temperature greater than 100° C., when the adhesive has already undergone a substantial degree of curing.

Because catalysts contemplated for use in the practice of the present invention are thermally initiated, articles (i.e., die/substrate combinations) to be adhered according to invention methods may be repositioned an unlimited number of times prior to the initiation of thermal curing. In contrast, prior art methods, many of which involve rendering adhesives “tacky” by pre-initiation treatment, do not allow for repositioning of a die after it has been contacted with a substrate. Moreover, curing of invention adhesives, and the concomitant formation of a substantially void-free bond, requires only the single step of providing sufficient thermal energy to initiate and sustain the curing reaction, wherein the cure peak maximum occurs at a temperature of less than 100° C.

Presently preferred catalysts contemplated for use herein are those which promote curing of adhesive formulations at a rate such that the cure peak maximum occurs at a temperature of no greater than about 90° C. Especially preferred catalysts contemplated for use herein are those which promote curing of adhesive formulations at a rate such that the cure peak maximum occurs at a temperature of no greater than about 80° C.

Even more preferred for use herein are catalysts which promote curing of adhesive formulations at a rate such that the cure peak maximum occurs at a temperature of no greater than about 70° C., with catalysts which promote curing of adhesive formulations at a rate such that the cure peak maximum occurs at a temperature of no greater than about 60° C. being especially preferred with certain adhesive formulations.

Catalysts contemplated for use in the practice of the present invention include free radical catalysts, anionic cure catalysts, cationic cure catalysts, transition metal catalysts, and the like, as well as combinations of any two or more thereof

Exemplary free radical catalysts contemplated for use in the practice of the present invention include peroxy esters, peroxy carbonates, hydroperoxides, alkylperoxides, arylperoxides, and the like. Specific free radical initiators contemplated for use herein include cumyl peroxyneodecanoate, cumyl peroxyneoheptanoate, tert-amyl peroxyneodecanoate, tert-butyl peroxyneodecanoate, tert-amyl peroxyneoheptanoate, tert-butyl peroxyneoheptanoate, a peroxydicarbonate, 2,4,4-trimethylpentyl-2-peroxyneodecanoate, di(n-propyl) peroxydicarbonate, di-(sec-butyl) peroxydicarbonate, di-(4-tert-butylcyclohexyl) peroxydicarbonate, di-(2-ethylhexyl) peroxydicarbonate, dimyristyl peroxydicarbonate, tert-amyl peroxypivalate, tert-butyl peroxypivalate, di-[3,5,5-trimethylhexanoyl]peroxide, decanoyl peroxide, lauroyl peroxide, dilauroyl peroxide, di-isononanoyl peroxide, 2,5-dimethyl-2,5-di(2-ethylhexanoylperoxy) hexane, 1-amyl peroxy 2-ethylhexanoate, and the like, as well as combinations of any two or more thereof.

Exemplary anionic cure catalysts contemplated for use in the practice of the present invention include imidazoles, tertiary amines, and the like. Imidazoles contemplated for use herein are those having the generic structure:

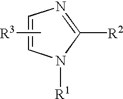

wherein:

R¹ is selected from the group consisting of alkyl, aryl and cyano moieties;

R² is selected from the group consisting of alkyl, aryl and cyano moieties; and

R³ is selected from the group consisting of alkyl, substituted alkyl, alkylaryl and substituted alkylaryl moieties.

As employed herein, “alkyl” refers to straight or branched chain alkyl radicals having in the range of about 1 up to 12 carbon atoms; “substituted alkyl” refers to alkyl radicals further bearing one or more substituents such as hydroxy, alkoxy (of a lower alkyl group), mercapto (of a lower alkyl group), aryl, heterocyclic, halogen, trifluoromethyl, cyano, nitro, amino, carboxyl, carbamate, sulfonyl, sulfonamide, and the like.

As employed herein, “aryl” refers to aromatic radicals having in the range of 6 up to 14 carbon atoms and “substituted aryl” refers to aryl radicals further bearing one or more substituents as set forth above.

As employed herein “alkylaryl” refers to alkyl-substituted aryl radicals and “substituted alkylaryl” refers to alkylaryl radicals further bearing one or more substituents as set forth above.

Exemplary imidazoles contemplated for use herein include 2-ethyl-4-methyl imidazole, 1-methyl imidazole, 2-methyl imidazole, 2-undecyl imidazole, 2-phenyl imidazole, and the like.

Tertiary amines contemplated for use herein include hexadecyldimethylamine, dihexadecylmethylamine, octadecyldimethyl-amine, dioctadecylmethylamine, dimethylbehenylamine, dimethyleicosylamine, N,N,N′-trimethyl-N′-hexadecyl- 1,2-diaminoethane, N,N,N′-trimethyl-N′-octadecyl-1,2-diaminoethane, N,N,N′-trimethyl-N′-eicosyl-1,2-diaminoethane, N,N,N′-trimethyl-N′-behenyl-1,2-diaminoethane, N,N,N′,N′-tetramethyl-1,20-diamino-(10,11-dioctyl)-eicosane, and the like, as well as mixtures of any two or more thereof.

Exemplary cationic cure catalysts contemplated for use in the practice of the present invention include onium salts, iodonium salts, sulfonium salts, and the like.

Exemplary transition metal catalysts contemplated for use in the practice of the present invention include nickel, copper, cobalt and the like, in the form of a chelate, a soap, or the like.

Generally in the range of about 0.005 up to 10 wt % of at least one of the above-described catalysts (based on the total weight of the organic phase, i.e., absent any filler) will be employed, with in the range of about 0.01 up to 5 wt % being presently preferred.

As readily recognized by those of skill in the art, a wide variety of devices can be bonded in accordance with the present invention. Examples of such devices include silicon-based microelectronic devices, gallium arsenide-based microelectronic devices, quartz-based microelectronic devices, sapphire-based microelectronic devices, indium phosphide-based microelectronic devices, cadmium sulfide-based microelectronic devices, lithium niobate-based microelectronic devices, and the like.

Those of skill in the art also readily recognize that a variety of substrates can be bonded in accordance with the present invention. Examples of such substrates are boards made of materials which tend to release volatiles upon exposure to elevated temperatures, e.g., boards made of materials which tend to absorb water. Examples of such boards include bismaleimide-triazine boards, epoxy boards, boards having a polyimide film thereon, boards having a polycarbonate film thereon, boards having a solder mask coating thereon, and the like.

In accordance with another embodiment of the present invention, there are provided adhesive compositions useful for attaching a device to a substrate, wherein said device and/or said substrate are prone to release volatiles at elevated temperatures, and wherein there is substantially no void formation upon curing thereof. Invention compositions comprise:

vehicle, and

a catalyst which promotes curing of said vehicle such that the cure peak maximum is no greater than about 100° C.

Vehicles contemplated for use in the practice of the present invention include cyanate ester-based formulations, maleimide-based formulations, epoxy-based formulations, (meth)acrylate-based formulations, vinyl ether-based formulations, vinyl ester-based formulations, allyl ester-based formulations, diallyl amide-based formulations, propargyl ether-based formulations, formulations based on a polysiloxane backbone terminated with one or more of the above-described functional groups, formulations based on a preimidized polyimide backbone terminated with one or more of the above-described functional groups, and the like, as well as mixtures of any two or more thereof, as described hereinabove.

Similarly, catalysts contemplated for use in the preparation of invention compositions are as described above, and such catalysts can be added to invention composition in amounts as set forth above.

In accordance with yet another embodiment of the present invention, there are provided substantially void-free articles prepared according to the above-described method. Such articles comprise a device attached to a substrate, wherein the device and/or the substrate are prone to release volatiles at elevated temperatures, and wherein the bond between the device and the substrate is substantially void-free.

As used herein, “substantially void-free” refers to a substantially continuous bond of adhesive between the interconnected device and substrate. Voids manifest as a disruption of this otherwise continuous bond and compromise both the strength of the resulting bond, and the ability of such bond to resist the influence of outside forces, such as high moisture levels, high shear forces, and the like.

The invention will now be described in greater detail by reference to the following non-limiting examples.

### EXAMPLE 1

A resin system was prepared for testing, using a base formulation as follows, and various different catalysts, to determine the effect of catalyst choice on the occurrence of voids upon curing. The base resin composition employed comprises:

60 parts by wt of the bismaleimide, 1,20-bismaleimido-10,11-dioctyl-eicosane,

30 parts by wt of maleated polybutadiene R130 MA20 from Ricon Resins, Grand Junction, Colo.),

22 parts by wt of a branched, C₂₄ monovinyl ether (i.e., the monovinyl ether of 2-decyl tetradecanol),

4 parts by wt of a coupling agent (e.g., 3 parts of A-186 (i.e., b-(3,4-epoxycyclohexyl)ethyl trimethoxysilane) and one part of A-174 (i.e., g-methacryloxypropyl trimethoxysilane), both of which are available from OSi Specialities, Endicott, N.Y.), and

1, 3 or 5 parts by wt of a catalyst.

Catalysts employed herein include Perkadox 16S (di-(4-tert-butylcyclohexyl)peroxydicarbonate, available from Akzo Nobel), Trigonox 141 (2,5-dimethyl-2,5-di-(2-ethylhexanoylperoxy)hexane, available from Akzo Nobel), and Witco USP90MD (1,1-bis(tert-amylperoxy)cyclohexane, available from Witco Chemical). Each of these catalysts has a 10 hour decomposition half life of 70° C. or less, and were added to the base formulation described above at levels of 1, 3 or 5 parts by wt. Thus, nine pastes were made for testing, each filled with 77 wt % silver flake. A differential scanning calorimetr (DSC) and a void test was performed on each paste.

The void test was performed using a copper-clad BT (bismaleimide-triazine) resin with Taiyo PSR 4000 version AUS5 solder mask. The substrate was placed in an 85/85 chamber for 15-16 hours to insure that moisture absorption would be evident. The nine plates were attached to the substrate using a glass cover slide 300×300 mils. The pastes were cured at 150° C. for 60 seconds on a hot plate apparatus.

The DSC was performed at a ramp rate of 10° /C. min. The sample size used was about 20-30 mg. Analysis of the DSC shows the onset of cure, the cure peak maximum and the total energy evolved. The cure onset temperature and the cure peak maximum temperature are presented in the Table for each of the pastes.

TABLE

| Paste* | Cure onset, ° C. | Cure peak, ° C. | % Voids |
|---|---|---|---|
| A | 84.20 | 90.46 | 0 |
| B | 77.38 | 82.28 | 0 |
| C | 74.04 | 78.90 | 0 |
| D | 102.62 | 113.15 | 100 |
| E | 95.08 | 103.74 | 100 |
| F | 90.13 | 99.16 | 0 |
| G | 117.79 | 129.08 | 100 |
| H | 111.66 | 122.43 | 100 |
| I | 109.32 | 118.97 | 100 |

*Pastes A, B and C contain 1, 3 and 5 parts by wt, respectively, of Perkadox 16S;
Pastes D, E and F contain 1, 3 and 5 parts by wt, respectively, of Trigonox 141; and
Pastes G, H and I contain 1, 3 and 5 parts by wt, respectively, of Witco USP90MD.

The results presented above demonstrate that voiding under the die does not occur with moisture sensitive polymers so long as the cure onset and cure peak maximum temperatures are both below 100° C.

While the invention has been described in detail with reference to certain preferred embodiments thereof, it will be understood that modifications and variations are within the spirit and scope of that which is described and claimed.

That which is claimed is:

1. A method of obtaining a substantially void-free bond between a surface of a device and a surface of a substrate, said method consisting essentially of:
(a) applying an adhesive formulation to said surface of said device and/or said surface of said substrate, wherein said adhesive formulation comprises a curing catalyst which promotes curing of said adhesive formulation such that the cure peak maximum is no greater than about 100° C.,
(b) contacting said surface of said device with said surface of said substrate, and
(c) subjecting said adhesive formulation to a temperature sufficient to cure said adhesive, wherein said cured adhesive and a resulting bond formed therewith are substantially void-free.

2. A method according to claim 1, wherein said cure peak maximum is no greater than about 90° C.

3. A method according to claim 1, wherein said cure peak maximum is no greater than about 80° C.

4. A method according to claim 1, wherein said cure peak maximum is no greater than about 70° C.

5. A method according to claim 1, wherein said cure peak maximum is no greater than about 60° C.

6. A method according to claim 1, wherein said cured adhesive formulation is stable up to about 250° C.

7. A method according to claim 1, wherein said curing catalyst is a free radical catalyst, an anionic cure catalyst, a cationic cure catalyst, a transition metal catalyst, or a combination of any two or more thereof.

8. A method according to claim 7, wherein said free radical catalyst is selected from the group consisting of cumyl peroxyneodecanoate, cumyl peroxyneoheptanoate, tert-amyl peroxyneodecanoate, tert-butyl peroxyneodecanoate, tert-amyl peroxyneoheptanoate, tert-butyl peroxyneoheptanoate, a peroxydicarbonate, 2,4,4-trimethylpentyl-2-peroxyneodecanoate, di(n-propyl) peroxydicarbonate, di-(sec-butyl) peroxdicarbonate, di-(4-tert-butylcyclohexyl) peroxydicarbonate, di-(2-ethylhexyl) peroxydicarbonate, dimyristyl peroxydicarbonate, tert-amyl peroxypivalate, tert-butyl peroxypivalate, di-[3,5,5-trimethylhexanoyl]peroxide, decanoyl peroxide, lauroyl peroxide, dilauroyl peroxide, di-isononanoyl peroxide, 2,5-dimethyl-2,5-di(2-ethylhexanoylperoxy) hexane and 1-amyl peroxy 2-ethylhexanoate.

9. A method according to claim 1, wherein said adhesive formulation is a cyanate ester-based formulation, a maleimide-based formulation, an epoxy-based formulation, a (meth)acrylate-based formulation, a vinyl ether-based formulation, a vinyl ester-based formulation, an allyl ester-based formulation, a diallyl amide-based formulation a propargyl ether-based formulation, formulations based on a polysiloxane backbone terminated with one or more of the above-described functional groups, formulations based on a preimidized polyimide backbone terminated with one or more of the above-described functional groups, or a mixture of any two or more thereof.

10. A method according to claim 9, wherein said adhesive formulation comprises a mixture of maleimide and vinyl ether.

11. A method according to claim 1, wherein said adhesive composition further comprises at least one filler.

12. A method according to claim 11, wherein said filler is electrically conductive.

13. A method according to claim 12, wherein said device is a silicon-based microelectronic device, a gallium arsenide-based microelectronic device, a quartz-based microelectronic device, a sapphire-based microelectronic device, an indium phosphide-based microelectronic device, a cadmium sulfide-based microelectronic device, or a lithium niobate-based microelectronic device.

14. A method according to claim 1, wherein said substrate is a board which releases volatiles upon exposure to elevated temperatures.

15. A method according to claim 14, wherein said substrate is a bismaleimide-triazine board, an epoxy board, a board having a polyimide film thereon, a board having a polycarbonate film thereon, or a board having a solder mask coating thereon.

16. A substantially void-free article prepared according to the method of claim 11.

17. A single step method for rapidly thermally curing an adhesive formulation, said method consisting essentially of subjecting said adhesive formulation to a temperature sufficient to cure said adhesive,
wherein said adhesive comprises a vehicle and a curing catalyst, and
wherein said curing catalyst promotes curing of said adhesive formulation such that the cure peak maximum is no greater than about 100° C.

18. A method for controllably obtaining a substantially void-free bond between a surface of a device and a surface of a substrate, said method comprising:
(a) applying an adhesive formulation to said surface of said device and/or said surface of said substrate, wherein said adhesive formulation comprises a vehicle and a curing catalyst which promotes curing of said adhesive formulation such that the cure peak maximum is no greater than about 100° C.,
(b) contacting said surface of said device with said surface of said substrate, and thereafter
(c) subjecting said adhesive formulation to a temperature sufficient to cure said adhesive formulation,
wherein subsequent to said contacting and prior to said curing of said adhesive formulation, said device and said substrate may be repositioned with respect to each other.

19. A method for bonding a device to a substrate, said method comprising:
(a) bringing said substrate and said device into intimate contact to form an assembly such that said substrate and said device are separated only by an adhesive formulation, and
(b) subjecting said assembly to conditions suitable to effect a cure of said adhesive formulation,
wherein said adhesive formulation comprises a curing catalyst which initiates thermal curing of said adhesive formulation such that the cure peak maximum is no greater than about 100° C. and is sufficient to cure said adhesive without the need for activation.

20. An article comprising a device attached to a substrate, wherein said device is bonded to said substrate by a method according to claim 1.

21. A method of obtaining a substantially void-free bond between a surface of a device and a surface of a substrate, said method consisting essentially of:
(a) contacting a surface of said device with a surface of said substrate, wherein an adhesive formulation has been applied to said surface of said device and/or said surface of said substrate, said adhesive formulation comprising a curing catalyst which promotes curing of said adhesive formulation such that the cure peak maximum is no greater than about 100° C.,
(b) subjecting said adhesive formulation to a temperature sufficient to cure said adhesive, wherein said cured adhesive and a resulting bond formed therewith are substantially void-free.
